(19) United States
(12) Patent Application Publication
(10) Pub. No.: US 2025/0292070 A1
(43) Pub. Date: Sep. 18, 2025

(54) QUESTION ANSWERING DEVICE AND QUESTION ANSWERING METHOD

(71) Applicant: Toshiba Tec Kabushiki Kaisha, Tokyo (JP)

(72) Inventor: Takesi KAWAGUTI, Mishima Shizuoka (JP)

(21) Appl. No.: 19/034,328

(22) Filed: Jan. 22, 2025

(30) Foreign Application Priority Data
Mar. 13, 2024 (JP) 2024-038904

(51) Int. Cl. G06N 3/0475; G06F 40/35

(52) U.S. Cl. CPC G06N 3/0475; G06F 40/35

(57) ABSTRACT

According to one embodiment, a question answering device includes a control unit and a communication interface connectable to a questioner terminal. The control unit id configured to receive a question from the questioner terminal via the communication interface, then generate a first response to the question using a first local large-scale language model (LLM). The control unit then generates an accuracy determination for the first response. The control unit provides the question to a second response generation unit if the accuracy determination indicates accuracy of the first response is low, and then sends a second response to the questioner terminal via the communication interface if the second response is received from the second response generation unit after the accuracy determination indicates the accuracy of the first response is low.

### CROSS-REFERENCE TO RELATED APPLICATION

This application is based upon and claims the benefit of priority from Japanese Patent Application No. 2024-038904, filed Mar. 13, 2024, the entire contents of which are incorporated herein by reference.

### FIELD

Exemplary embodiments described herein relate to a question answering device, and a question answering method.

### BACKGROUND

In recent years, large-scale language models (LLMs) such as represented by ChatGPT and the like have attracted attention. However, a cloud-based LLM is generally not suitable for services that involve transfer of personal information or for a low-latency, real-time processing that so-called “edge devices” excel at.

Local LLMs, which are small in size and can be run on local devices, are also being released. Generally, the local LLMs do not match a cloud-based LLM service in terms of functionality, but it is thought that the local LLMs can be used when the local LLM has been optimized for a specific use or function. Methods such as fine tuning can be used to achieve this local LLM optimization for specific functions/uses.

The potential benefits of using a local LLM includes the ability to handle data, such as personal information, that cannot be uploaded to the cloud for various reasons, and the ability to provide immediate responsiveness by running locally or on the edge.

As a use case of such a local LLM, a system that automatically generates a response to a question as disclosed in Japanese Patent Publication JP2022-86817A is considered.

However, in the system disclosed in JP2022-86817A, if accuracy of the automatically generated response is low, a questioner must then directly communicate with a responder to obtain a suitable response.

### BRIEF DESCRIPTION OF THE DRAWINGS

FIG. 1 is a schematic configuration diagram illustrating a question answering system including a store server to which a question answering device according to a first embodiment is applied.

FIG. 2 is a block diagram illustrating an example of a functional configuration of the store server.

FIG. 3 is a sequence diagram illustrating an operation outline of a question answering system.

FIG. 4 is a sequence diagram illustrating an operation outline.

FIG. 5 is a flowchart illustrating aspects of a procedure of question answering executed by a processor of a store server.

FIG. 6 is a sequence diagram illustrating an operation outline of a question answering system including a store server to which a question answering device according to a second embodiment is incorporated.

FIG. 7 is a flowchart illustrating aspects of a procedure of question answering executed by a processor of a store server in the second embodiment.

FIG. 8 is a block diagram illustrating an example of a functional configuration of a store server in which a question answering device according to a third embodiment is incorporated.

### DETAILED DESCRIPTION

An object of the embodiments is to provide a question answering device and a question answering method capable of providing an appropriate response to a questioner without causing the questioner to become bothersome even if accuracy of a response automatically generated using a local LLM is low.

According to one embodiment, a question answering device includes a control unit and communication interface connectable to a questioner terminal. The control unit is configured to receive a question from the questioner terminal via the communication interface, generate a first response to the question using a first local large-scale language model (LLM), and then generate an accuracy determination for the first response. The control is further configured to provide the question to a second response generation unit if the accuracy determination indicates accuracy of the first response is low, and then send a second response to the questioner terminal via the communication interface when the second response is received from the second response generation unit after the accuracy determination indicates accuracy of the first response is low.

Hereinafter, certain example embodiments of a question answering device will be described with reference to the drawings.

### First Embodiment

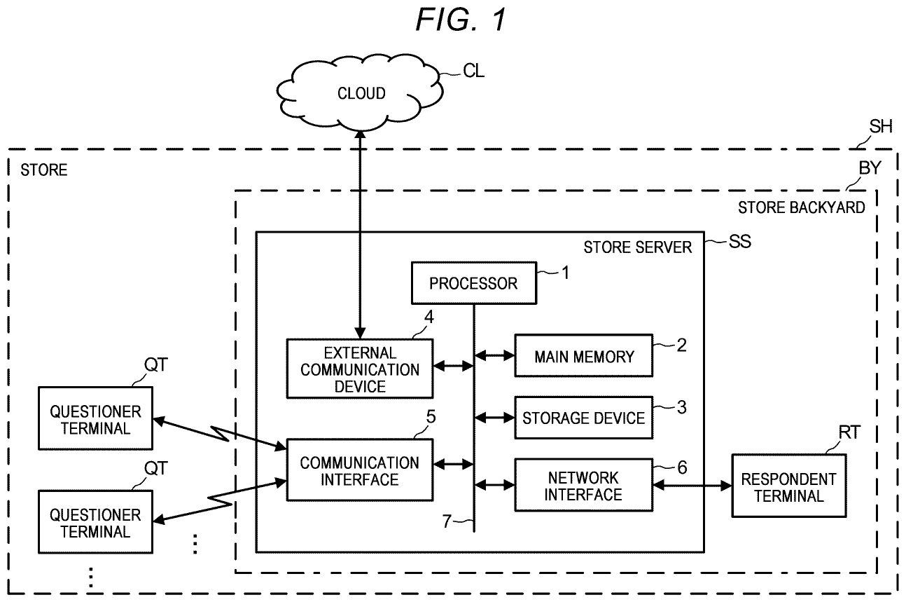

FIG. 1 is a schematic configuration diagram illustrating a question answering system including a store server SS to which a question answering device according to a first embodiment is applied. The question answering system includes a plurality of questioner terminals QT and a respondent terminal RT in addition to the store server SS. In FIG. 1, one respondent terminal RT is provided, but a plurality of respondent terminals RT may be provided. The store server SS is an edge server connected to the cloud CL. The store server SS can be installed in a store backyard BY (e.g., a backroom or back office) at a store SH. The questioner terminals QT are disposed in the store SH, and the respondent terminal RT is in the store backyard BY.

The store server SS includes a processor 1, a main memory 2, a storage device 3, an external communication device 4, a communication interface 5, a network interface 6, and a bus line 7. The bus line 7 communicably connects the processor 1, the main memory 2, the storage device 3, the external communication device 4, the communication interface 5, and the network interface 6. The bus line 7 includes an address bus, a data bus, a control signal line, and the like. The bus line 7 connects the processor 1 and other units directly or via a signal input and output (I/O) circuit, and transmits data signals exchanged therebetween. The processor 1 and the main memory 2 are connected to each other by the bus line 7, thereby implementing a computer serving as a control unit of the store server SS.

The processor 1 can be a hardware processor corresponding to a central part of the above computer. The processor 1 controls, in accordance with an operating system and a control program, each unit to implement various functions of the store server SS. The processor 1 is, for example, a central processing unit (CPU). The processor 1 may be a micro processing unit (MPU) instead of the CPU. If the processor 1 is a multi-core/multi-thread processor, the processor 1 can execute a plurality of processes in parallel. It may be preferable that the processor 1 further includes a graphics processing unit (GPU) for machine learning functions. The processor 1 may also be implemented in a variety of other forms, including an integrated circuit such as an application specific integrated circuit (ASIC), a graphics processing unit (GPU), a field-programmable gate array (FPGA), a digital signal processor (DSP), a system on a chip (SOC), a programmable logic device (PLD), and the like. Alternatively, the processor 1 may be a combination of these described above.

The main memory 2 includes a non-volatile memory area and a volatile memory area. The main memory 2 stores an operating system in the non-volatile memory area. Further, the non-volatile memory area can store various control programs. The main memory 2 may store data in the non-volatile or volatile memory area necessary for the processor 1 to execute a process for controlling each unit. The main memory 2 uses the volatile memory area as a work area in which data may be appropriately rewritten by the processor 1. The non-volatile memory area is, for example, a read only memory (ROM). The volatile memory area is, for example, a random access memory (RAM).

The storage device 3 corresponds to, for example, an electric erasable programmable read-only memory (EEPROM), a hard disc drive (HDD), or a solid-state drive (SSD). The storage device 3 stores data used by the processor 1, data created by the processor 1, and the like. For example, the storage device 3 can store learning data for a local LLM. The storage device 3 may store the above-referenced control program(s). For example, the storage device 3 stores a question answering program according to an embodiment, a local LLM, learning data, and the like.

The external communication device 4 communicates with the cloud CL.

The communication interface 5 communicates with the questioner terminals QT disposed in the store SH in a wired or wireless manner.

The network interface 6 communicates with the respondent terminal RT via an in-store network such as a local area network (LAN).

In some examples, the store server SS may include only one of the communication interface 5 or the network interface 6. That is, the respondent terminal RT may communicate via the communication interface 5. Similarly, the questioner terminals QT may be connected to the in-store network directly or via a wireless access point or the like.

The questioner terminal QT is, for example, an information processing terminal such as a personal computer (PC) installed at a fixed place in the store SH or a tablet terminal loaned to a customer for use during a visit to the store SH. The questioner terminal QT may also or instead be a tablet terminal or a smartphone owned by the customer and brought to the store SH. The questioner terminal QT can be any terminal capable of executing Web browser application software. For example, the customer can access a Web site for receiving a question prepared in advance by the store SH, input a question, and view a response to the question. If the questioner terminal QT is a smartphone owned by a customer or the like, the questioner terminal QT may communicate with the external communication device 4 via the cloud CL instead of the communication interface 5.

The respondent terminal RT is a PC or the like operated by a respondent (designated responder) such as a store clerk at the store SH.

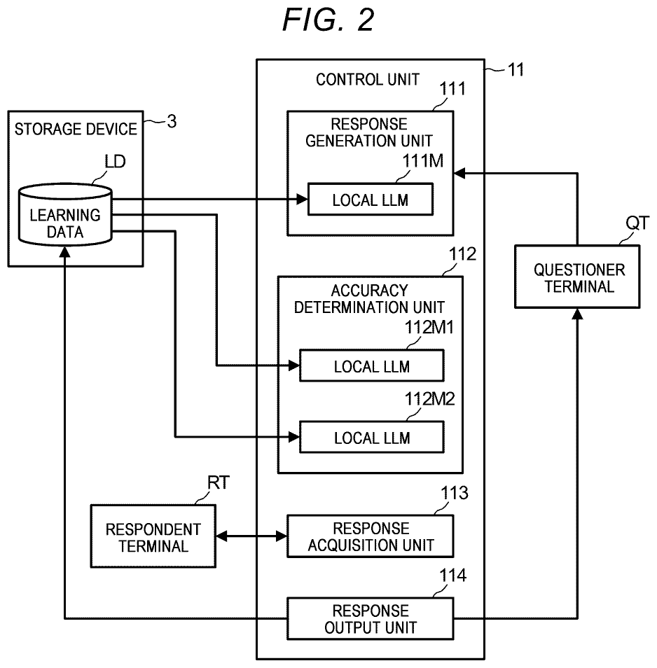

FIG. 2 is a block diagram illustrating an example of a functional configuration of the store server SS. The processor 1 of the store server SS is connected to the main memory 2 and executes the control program stored in the main memory 2, particularly, the question answering program according to the present embodiment, thereby implementing a control unit 11 as illustrated in FIG. 2. The control unit 11 provides a response generation unit 111, an accuracy determination unit 112, a response acquisition unit 113, and a response output unit 114. Each unit implemented by the control unit 11 can also be referred to as a function. It can also be said that each unit implemented by the control unit 11 is implemented by the processor 1.

The response generation unit 111 constructs a local LLM execution environment 111M for executing the local LLM stored in the storage device 3. The response generation unit 111 executes the local LLM in the local LLM execution environment 111M to generate a response document to a question received from a questioner terminal QT operated by a customer (a questioner) who has a question to ask.

The accuracy determination unit 112 determines the accuracy of the response document generated by the response generation unit 111. The accuracy of the response document may be determined or estimated in any manner.

For example, the accuracy determination unit 112 determines a level of accuracy of the response based on whether the response document includes a specific word of interest associated with a word contained in the submitted question. The accuracy determination unit 112 may determine an accuracy level by determining whether the response document includes a hedging word or phrase such as “I don't know” or “I wonder”. In the present example, the accuracy determination unit 112 calculates an accuracy score such that the accuracy score value decreases as the number of specific words of interest included in the response document increases, and estimates that the accuracy is low when the score value is equal to or less than some predetermined threshold value.

As illustrated in FIG. 2, the accuracy determination unit 112 may construct local LLM execution environments 112M1 and 112M2 for executing local LLMs each having models different from that in the local LLM execution environment 111M of the response generation unit 111, and determine the accuracy level by using the respective local LLMS. In this example, the accuracy determination unit 112 executes different local LLMs in each of the local LLM execution environments 112M1 and 112M2, respectively, and generates separate response documents to the question received from the questioner terminal QT. Then, the accuracy determination unit 112 calculates a similarity score indicating a similarity between each generated response document and the response document generated by the response generation unit 111. If the calculated similarity score value is equal to or less than some predetermined threshold value, the accuracy determination unit 112 determines that the accuracy is low. In FIG. 2, two different local LLMs are depicted as executed, but the number of local LLMs utilized in this context may be any number of one or more.

If the accuracy determination unit 112 determines that the accuracy of the response document from the response generation unit 111 is low, the response acquisition unit 113 acquires a response document generated by the respondent terminal RT, which is a response generation device different from the response generation unit 111. Specifically, the response acquisition unit 113 transmits the question received from the questioner terminal QT and the response document generated by the response generation unit 111 to the respondent terminal RT. A respondent, who is a human operator of the respondent terminal RT, views the question and the response document, and then inputs or provides an updated response document with updated response content. The respondent terminal RT returns the updated response document to the response acquisition unit 113. The response acquisition unit 113 thus acquires the returned updated from response document the respondent terminal RT.

The response output unit 114 outputs a response document generated by either the response generation unit 111 or acquired by the response acquisition unit 113 to the questioner terminal QT. When the accuracy determination unit 112 determines that the accuracy of the response document generated by the response generation unit 111 is high, the response output unit 114 simply outputs the response document generated by the response generation unit 111 to the questioner terminal QT. On the other hand, if the accuracy determination unit 112 determines that the accuracy of the response document generated by the response generation unit 111 is low, the response output unit 114 ultimately outputs the response document acquired by the response acquisition unit 113 to the questioner terminal QT. Furthermore, in the latter case, the response output unit 114 also updates learning data LD according to the question received from the questioner terminal QT and the response document acquired by the response acquisition unit 113, thereby updating and improving each local LLM.

Hereinafter, an operation of the store server SS to which the question answering device according to the present embodiment is applied and a question answering system including such a store server SS will be described.

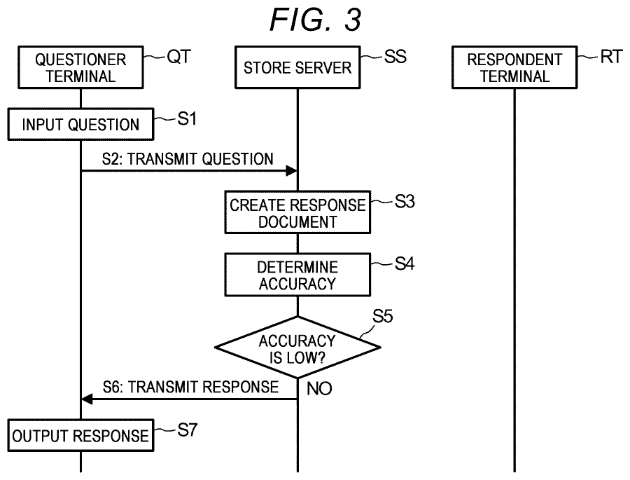

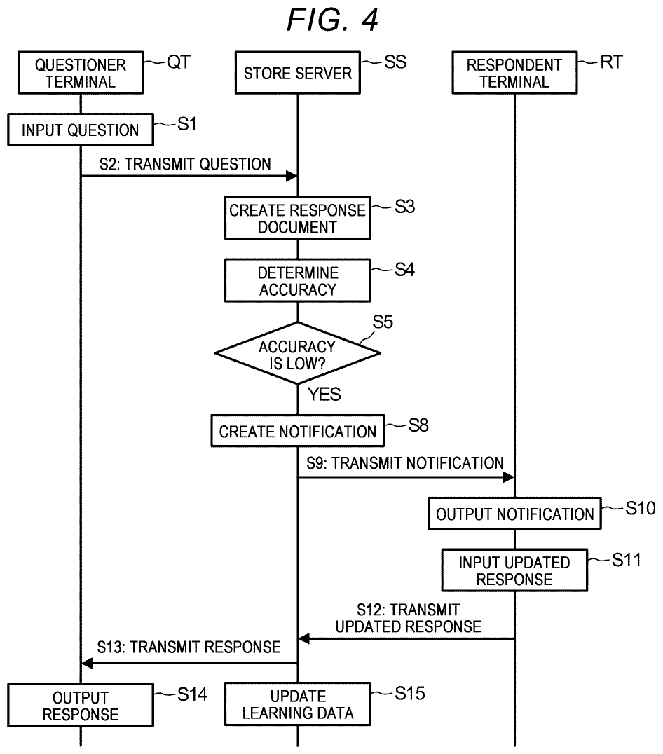

FIGS. 3 and 4 are sequence diagrams illustrating an operation outline of the question answering system. Here, FIG. 3 illustrates a case where the accuracy of the response document generated by the response generation unit 111 is high, and FIG. 4 illustrates a case where the accuracy of the response document generated by the response generation unit 111 is low.

First, the case where the accuracy of the response document is high will be described with reference to FIG. 3.

The questioner terminal QT receives an input of a question from a customer (step S1). Then, the questioner terminal QT transmits the received question to the store server SS (step S2).

Upon receiving the question transmitted from the questioner terminal QT, the store server SS executes the local LLM using the local LLM execution environment 111M, and creates a response document for the submitted question (step S3). Thereafter, the store server SS determines accuracy of the just created response document (step S4). Then, the store server SS checks whether the determined accuracy is low (step S5). Here, if the accuracy is not low (that is, the accuracy is high), the store server SS transmits the response document created in step S3 to the questioner terminal QT (step S6).

The questioner terminal QT then displays/outputs the response document transmitted from the store server SS (step S7).

Next, the case where the accuracy of the response document is low will be described with reference to FIG. 4.

Step S1 to step S5 are the same as described above. If it is determined in step S5 that the accuracy of the response document created in step S3 is low, the store server SS creates a notification to be transmitted to the respondent terminal RT (step S8). The notification includes the question transmitted from the questioner terminal QT and the already created response document. Then, the store server SS transmits this notification to the respondent terminal RT (step S9).

The respondent terminal RT receives the notification from the store server SS, and displays/outputs the notification (step S10). After reviewing the notification, a store clerk (or other respondent) operates the respondent terminal RT to provide an updated response document by, for example, modifying the response document included in the notification or by creating a different response document such that the response document is appropriate for the question included in the notification (step S11). The respondent terminal RT transmits, to the store server SS, the updated response document thus input (step S12).

After receiving the updated response document, the store server SS transmits the updated response document to the questioner terminal QT (step S13).

The questioner terminal QT displays/outputs the updated response document sent from the store server SS (step S14).

In addition to transmitting the updated response document (step S13), the store server SS also updates the learning data LD with the updated response document and the question corresponding thereto in step S15.

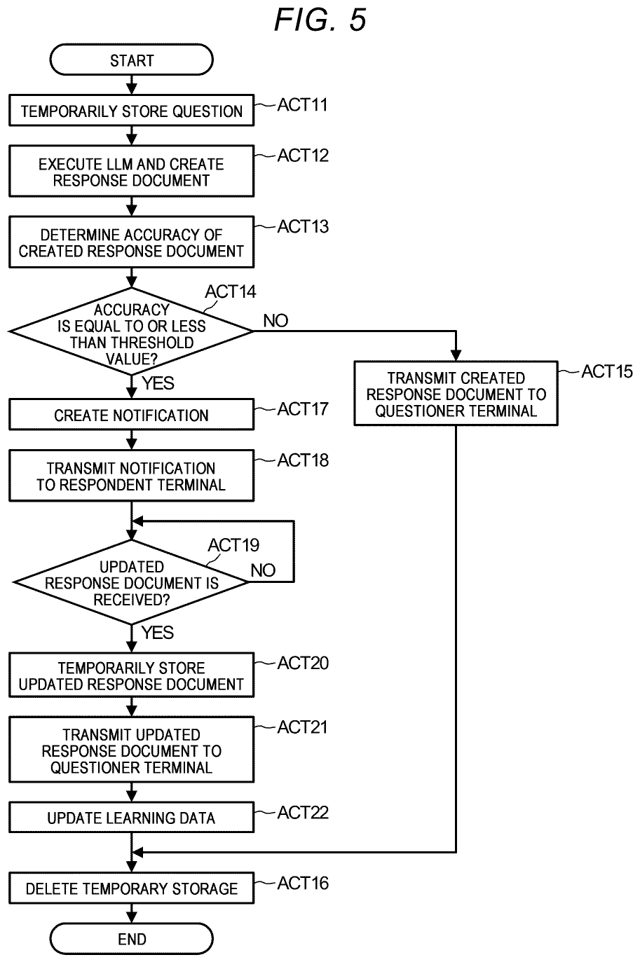

Next, a specific example of the operation of the store server SS to which a question answering device according to the first embodiment is applied will be described. FIG. 5 is a flowchart illustrating aspects of a procedure of question answering executed by the processor 1 in the store server SS. For example, when receiving a question from any one of the questioner terminals QT via the communication interface 5, the processor 1 executes the question answering based on the question answering program stored in the main memory 2. When receiving questions from multiple questioner terminals QT, the processor 1 can simultaneously perform these answering operations in parallel. Unless otherwise specified, it may be assumed that a process operation of the processor 1 transitions from ACT x (where x is a natural number) in FIG. 5 to ACT (x+1) once ACT x has been completed. The procedure illustrated in FIG. 5 is one example. The specific procedure adopted is not particularly limited as long as a similar result to that described can be obtained.

In ACT 11, the response generation unit 111 implemented in the processor 1 temporarily stores, in the volatile memory area of the main memory 2, the question from a questioner terminal QT that was received by the communication interface 5. At this time, the response generation unit 111 temporarily stores, in the main memory 2, some information for specifying the sending questioner terminal QT, such as terminal identification information, an IP address, and/or a terminal number of the questioner terminal QT, in association with the question, thereby particularly identifying which questioner terminal QT sent the question.

In ACT 12, the response generation unit 111 implemented in the processor 1 executes a local LLM using the local LLM execution environment 111M, and creates a response document corresponding to the question stored in the main memory 2. The created response document is also temporarily stored in the main memory 2 in the same manner as the question.

In ACT 13, the accuracy determination unit 112 implemented in the processor 1 checks accuracy of the created response document.

In ACT 14, the accuracy determination unit 112 implemented in the processor 1 determines whether the accuracy is equal to or less than a threshold value. That is, the accuracy determination unit 112 checks whether the determined accuracy is low. If the accuracy is equal to or less than the threshold value, that is, the accuracy is low, the accuracy determination unit 112 determines YES in ACT 14. In this case, the processor 1 proceeds to ACT 17. If the accuracy is greater than the threshold value, that is, the accuracy is high, the accuracy determination unit 112 determines NO in ACT 14. In this case, the processor 1 proceeds to ACT 15.

In ACT 15, the response output unit 114 implemented in the processor 1 transmits, through the communication interface 5, the created response document (a response to the question) to the questioner terminal QT from which the question was transmitted.

In ACT 16, the response output unit 114 implemented in the processor 1 deletes the data that was temporarily stored in the main memory 2, in this case, the question, the information identifying the questioner terminal QT from which the question is transmitted, and the created response document. Then, the processor 1 ends the question answering processing.

In ACT 17, the response acquisition unit 113 implemented in the processor 1 creates a notification including the question and the response document that were stored in the main memory 2.

In ACT 18, the response acquisition unit 113 implemented in the processor 1 transmits the notification to the respondent terminal RT through the network interface 6.

In ACT 19, the response acquisition unit 113 implemented in the processor 1 checks whether an updated response document has been received from the respondent terminal RT through the network interface 6. If the updated response document is not yet received, the response acquisition unit 113 determines NO in ACT 19. In this case, the processor 1 executes ACT 19 again (waits). Once the updated response document is received from the respondent terminal RT, the response acquisition unit 113 determines YES in ACT 19. In this case, the processor 1 proceeds to ACT 20.

In ACT 20, the response acquisition unit 113 implemented in the processor 1 temporarily stores the updated response document in the main memory 2.

In ACT 21, the response output unit 114 implemented in the processor 1 transmits, through the communication interface 5, the received updated response document as a response to the question to the questioner terminal QT from which the question is transmitted.

In ACT 22, the response output unit 114 implemented in the processor 1 updates the learning data LD stored in the storage device 3 based on the question and the corresponding updated response document.

Thereafter, the response output unit 114 proceeds to ACT 16 and deletes the data that was temporarily stored in the main memory 2. The data deleted in this case is the question, the information identifying the questioner terminal QT from which the question was transmitted, the created response document, and the updated response document.

As described above, the store server SS to which the question answering device according to the first embodiment is applied causes the response generation unit 111 to create a response document (as a first response to the question received from the questioner terminal QT) using the local LLM using the local LLM execution environment 111M and causes the accuracy determination unit 112 to check the accuracy of this first response. Here, if the accuracy determined by the accuracy determination unit 112 is equal to or less than some threshold value, the store server SS causes the response acquisition unit 113 to supply the question to a response generation device different from the response generation unit 111 and acquire an updated response document. The store server SS causes the response output unit 114 to output the first response generated by the response generation unit 111 or the second response acquired by the response acquisition unit 113 to the questioner terminal QT.

As described above, according to the store server SS in the first embodiment, if the accuracy of the response document automatically generated using the local LLM is low, the response generation device generates an updated response document, and the updated response document is output to the questioner terminal QT. Accordingly, even if the accuracy of the response automatically generated using the local LLM is low, an appropriate response can still be provided to a questioner without causing the questioner to become bothersome.

Here, the response output unit 114 of the store server SS outputs the first response generated by the response generation unit 111 to the questioner terminal QT if the accuracy determined by the accuracy determination unit 112 is greater than a threshold value, and outputs the second response acquired by the response acquisition unit 113 to the questioner terminal QT if the accuracy determined by the accuracy determination unit 112 is equal to or less than the threshold value.

Therefore, according to the store server SS in the first embodiment, since either the first or second response can be provided to the questioner terminal QT, the questioner can be prevented from becoming confused by being presented with two responses.

In the question answering system according to the first embodiment, t the second response can be provided by the response acquisition unit 113 from a respondent terminal RT at which the respondent inputs a response to the question. In this case, the response acquisition unit 113 of the store server SS includes the network interface 6 which is a communication unit that transmits the question to the respondent terminal RT and receives the second response from the respondent terminal RT.

For example, a question about ingredients in a certain product, such as “please tell me the ingredients of AAA box lunch”, can be responded with high accuracy using the local LLM, such as “ingredients: rice, shrimp, tempura flour, egg, salad oil, tempura sauce (soy sauce, mirin, sake, sugar), and pickled radish”, since the question content is specific and the response can also be specific.

On the other hand, for a question like “Is the CCC menu item at BBB restaurant suitable for vegans?”, a response document generated using the local LLM may be “The ingredients in the menu item you mentioned are rice, shrimp, tempura flour, egg, salad oil, tempura sauce (soy sauce, mirin, sake, sugar), and pickled radish. The menu item contains animal-derived foods and is therefore not suitable for vegans.” However, in this case, the response may be expected to change depending on variable conditions. For example, if the menu item in question contains animal-derived foods or additives, the response may be generally “not suitable”, but if a cook is able to avoid using the animal-derived foods as ingredients without substantial burden, the best response may be “The menu item is not suitable for vegans as it contains animal-derived foods. However, upon request, the menu item can be prepared by replacing the animal-derived foods with plant-derived alternatives.” As another example, if the ingredients do not contain any animal-derived food, but there is no clear separation in the cooking area from menu items containing animal-derived foods, the response may be “Although an animal-derived food is not used, there are no separate cooking areas for preparation of menu items containing an animal-derived food and those not containing an animal-derived food, and therefore the menu is not recommended for strict vegans.”.

Therefore, when creating a response to certain questions that might depend on highly variable conditions, a more accurate response can be prepared according to the store server SS in the first embodiment by cooperating with a respondent such as store clerk or other person in charge.

In the question answering system according to the first embodiment, the response output unit 114 updates the learning data LD by adding the updated response document to the stored learning data LD together with the question from which the response was derived.

Therefore, the local LLM used by the response generation unit 111 and the accuracy determination unit 112 can be tuned using these respondent modified answers, and a response document having higher accuracy can be acquired for a next time the question or similar one is presented.

### Second Embodiment

Next, a second embodiment will be described. Configurations and operations similar to those in the first embodiment are denoted by the same reference symbols, and description thereof may be omitted.

Basic configurations of the store server SS to which a question answering device according to the second embodiment is applied and a question answering system including the store server SS are similar to those in the first embodiment.

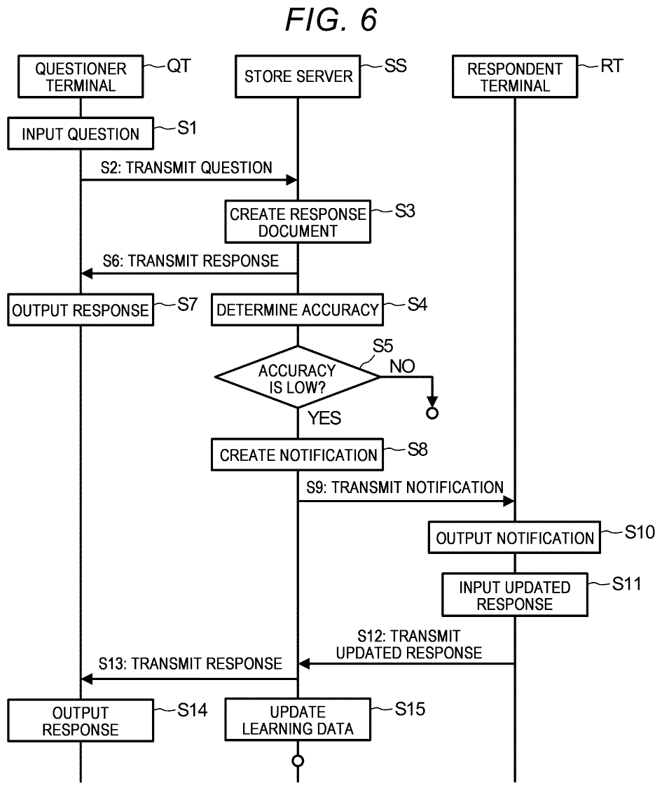

FIG. 6 is a sequence diagram illustrating an operation outline of the question answering system including the store server SS to which the question answering device according to the second embodiment is applied. In the second embodiment, after a response document is created in step S3, the store server SS transmits the created response document to the questioner terminal QT (step S6). After transmitting this response document, the store server SS then determines (checks) the accuracy of the response document in step S4, and determines whether the determined accuracy is low or not in step S5.

Here, if the accuracy of the created response document is not low (that is, the accuracy is high), the store server SS ends the process.

If the accuracy of the created response document is low, the process proceeds to step S8, and as described in the first embodiment, an updated response document is acquired and an updated response is eventually transmitted to the questioner terminal QT.

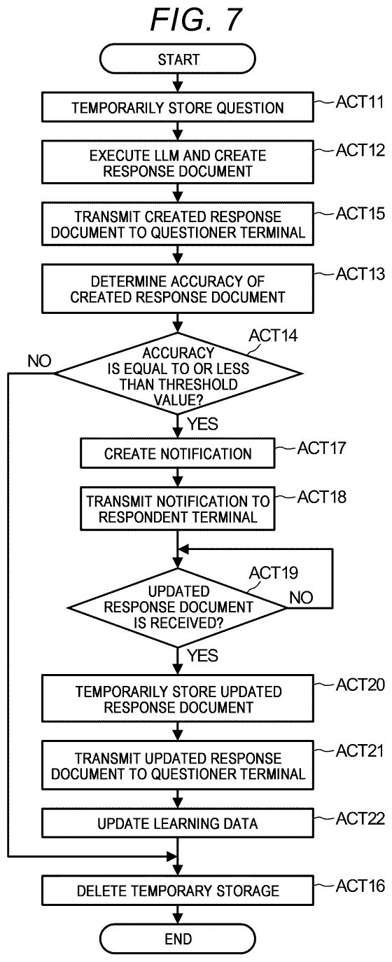

Next, a specific example of an operation of the store server SS to which the question answering device according to the second embodiment is applied will be described. FIG. 7 is a flowchart illustrating aspects of a procedure of question answering executed by the processor 1 of the store server SS in the second embodiment.

In the second embodiment, after the response generation unit 111 implemented in the processor 1 creates a response document in ACT 12, the processor 1 proceeds directly to ACT 15.

In ACT 15, the response output unit 114 implemented in the processor 1 transmits the created response document as a response to the question to the questioner terminal QT. Thereafter, the processor 1 proceeds to ACT 13.

The accuracy determination unit 112 implemented in the processor 1 determines accuracy of f the created response document in ACT 13, and determines whether the determined accuracy is equal to or less than a threshold value in ACT 14.

Here, if the accuracy is greater than the threshold value, that is, the accuracy is high, and the accuracy determination unit 112 determines NO, the processor 1 proceeds to ACT 16 in the present embodiment.

If the accuracy is equal to or less than the threshold the accuracy is low, and the accuracy value, that is, determination unit 112 thus determines YES, the processor 1 executes processes from ACT 18 as in the first embodiment.

As described above, according to the store server SS to which the question answering device according to the second embodiment is applied, the response output unit 114 outputs both the first response generated by the response generation unit 111 and any second response acquired by the response acquisition unit 113 to the questioner terminal QT. Specifically, the response output unit 114 of the store server SS outputs the first response generated by the response generation unit 111 to the questioner terminal QT regardless of the determined or estimated accuracy of the response document as determined by the accuracy determination unit 112, and then subsequently outputs, to the questioner terminal QT, a second response that is acquired by the response acquisition unit 113 when the accuracy determined by the accuracy determination unit 112 is considered low (that is, equal to or less than the threshold value).

Therefore, according to the store server SS in the second embodiment, whenever a response document is generated by the response generation unit 111, the response document is output to the questioner terminal QT, but if the accuracy of the generated response document is low, an updated response document (a second response) is acquired and output to the questioner terminal QT, and thus an initial response can be presented to the questioner in a responsive (fast) manner and the questioner can be prevented from being kept waiting an answer. This may be useful since it may take some noticeable amount of time for the respondent to provide/generate an updated response document.

If the accuracy determined by the accuracy determination unit 112 is equal to or less than the threshold value, the response output unit 114 may indicate to the questioner that a more accurate response is being prepared after the first response has been output.

### Third Embodiment

Next, a third embodiment will be described. Configurations and operations similar to those in the first embodiment are denoted by the same reference symbols, and additional description thereof may be omitted.

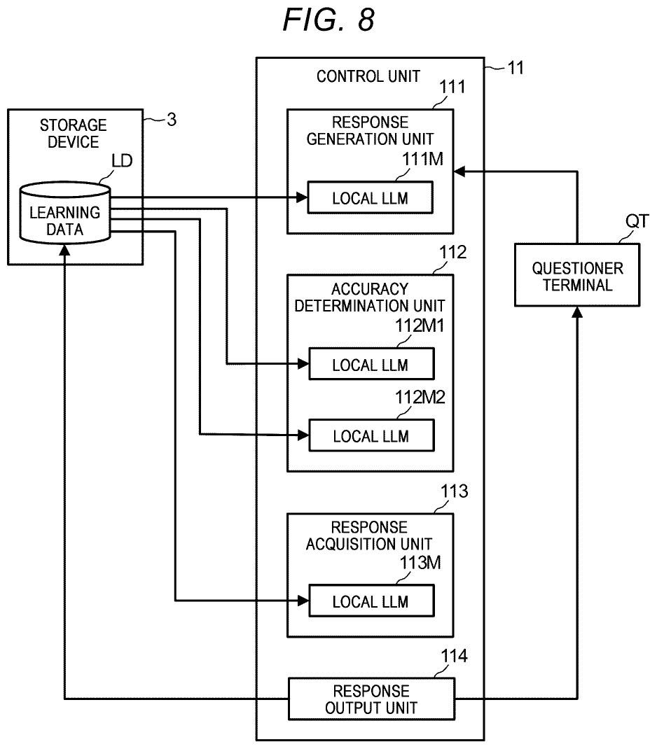

FIG. 8 is a block diagram illustrating an example of a functional configuration of the store server SS to which a question answering device according to the third embodiment is applied. In the third embodiment, the response acquisition unit 113 constructs a local LLM execution environment 113M for executing a local LLM having a model different from those in the local LLM execution environment 111M of the response generation unit 111 and the local LLM execution environments 112M1 and 112M2 of the accuracy determination unit 112. The response acquisition unit 113 gives a question to the local LLM of the local LLM execution environment 113M, and acquires an updated response document as the second response from this local LLM.

The response acquisition unit 113 in some examples need not use the response obtained from the local LLM in the local LLM execution environment 113M as the second response as it is, but rather may compare the similarity between its generated response document and the response document generated by the response generation unit 111, and then adopt only the portion(s) that are judged similar to the response document from the response generation unit 111.

In general, the operation of the third embodiment is the same as that in the first or second embodiment except that a method for acquiring an updated response document is different.

As described above, according to the store server SS to which the question answering device according to the third embodiment is applied, the response acquisition unit 113 includes, as a response generation device that generates the second (updated) response, the local LLM execution environment 113M, which is a second response generation unit that generates a response to a question using a local LLM having a model different from that of the local LLM of the response generation unit 111.

Therefore, according to the store server SS in the third embodiment, an updated response document can be provided to a questioner without requiring intervention of a respondent at a respondent terminal RT or the like.

In some examples, a response acquisition unit 113 of this third embodiment may acquire an updated response document using a high-performance LLM on cloud CL via the external communication device 4 instead of a local LLM in the store server SS.

Although certain example embodiments of the question answering device have been described above, the embodiments are not limited thereto.

For example, although an example in which the question answering device is applied to a store server SS has been described, the question answering device may be applied to an edge server disposed separately from the store server SS in the store SH. The question answering device can also be applied to other edge devices in the store SH such as an edge gateway instead of the server Further, a question answering device that communicates with the store server SS and executes the local LLM may be provided on the cloud CL side.

In some examples, the order of ACT 21 and ACT 22illustrated in the flowchart in FIG. 5 may be reversed or the acts may be performed in parallel rather than in sequence. As described above, the order of the processes may be changed or certain processes may be performed in parallel as long as no inconsistency with the preceding or subsequent process occurs.

It may be determined whether the accuracy of response is low based on whether the accuracy is equal to or less than the threshold value. Alternatively, it may be determined whether the accuracy is equal to or more than the threshold value or exceeds the threshold value, and if the accuracy is less than the threshold value or does not exceed the threshold value, it may be determined that the accuracy is low.

In the embodiment described above, the question answering program executed by the processor 1 of the store server SS may be recorded on a non-transitory, computer-readable recording medium such as a CD-ROM. The question answering program may be stored in a program providing server on the cloud CL, and may be downloaded by the external communication device 4 so as to be stored in the storage device 3.

While several embodiments of the exemplary embodiment have been described, the embodiments have been presented by way of example and are not intended to limit the scope of the exemplary embodiment. These novel embodiments can be implemented in various other forms, and various omissions, substitutions, and modifications can be made without departing from the gist of the disclosure. The embodiments and modifications thereof are included in the scope of the exemplary embodiments, and are included in a scope of the invention disclosed in the claims and equivalents thereof.

What is claimed is:

1. A question answering device, comprising:
a communication interface connectable to a questioner terminal; and
a control unit configured to:
receive a question from the questioner terminal via the communication interface,
generate a first response to the question using a first local large-scale language model (LLM),
generate an accuracy determination for the first response,
provide the question to a second response generation unit if the accuracy determination indicates accuracy of the first response is low, and
send a second response to the questioner terminal via the communication interface when the second response is received from the second response generation unit after the accuracy determination indicates accuracy of the first response is low.

2. The question answering device according to claim 1, wherein the control unit is further configured to:
send the first response to the questioner terminal via the communication interface if the accuracy determination indicates accuracy of the first response is not low.

3. The question answering device according to claim 1, wherein the control unit is further configured to:
send the first response to the questioner terminal via the communication interface before the accuracy determination is generated.

4. The question answering device according to claim 3, wherein the second response generation unit is a respondent terminal operated by a human.

5. The question answering device according to claim 1, wherein the second response generation unit is a respondent terminal operated by a human.

6. The question answering device according to claim 1, wherein the second response generation unit uses a second local LLM that is different from the first local LLM.

7. The question answering device according to claim 1, further comprising:
a storage device storing learning data for the first LLM, wherein
the control unit is further configured to:
update the stored learning data based on the received question and the second response when the second response is received from the second response generation unit after the accuracy determination indicates accuracy of the first response is low.

8. The question answering device according to claim 1, wherein the accuracy determination is generated by review of the first response for inclusion of specific keywords.

9. The question answering device according to claim 1, wherein the accuracy determination is generated by a comparison of the first response to another response to the question generated by another local LLM that is different from the first local LLM.

10. A store server for a question answering system, the store server comprising:
a communication interface connected to a questioner terminal; and
a processor executing a control program causing the processor to be configured to:
receive a question from the questioner terminal via the communication interface,
generate a first response to the question using a first local large-scale language model (LLM) executing in a local execution environment,
generate an accuracy determination for the first response,
provide the question to a second response generation unit if the accuracy determination indicates accuracy of the first response is low, and
send a second response to the questioner terminal via the communication interface when the second response is received from the second response generation unit after the accuracy determination indicates accuracy of the first response is low.

11. The store server according to claim 10, wherein the processor is further configured to:
send the first response to the questioner terminal via the communication interface if the accuracy determination indicates accuracy of the first response is not low.

12. The store server according to claim 10, wherein the processor is further configured to:
send the first response to the questioner terminal via the communication interface before the accuracy determination is generated.

13. The store server according to claim 10, wherein the second response generation unit is a respondent terminal operated by a human.

14. The store server according to claim 10, wherein the second response generation unit uses a second local LLM that is different from the first local LLM.

15. The store server according to claim 10, further comprising:
a storage device storing learning data for the first LLM, wherein
the processor is further configured to:
update the stored learning data based on the received question and the second response when the second response is received from the second response generation unit after the accuracy determination indicates accuracy of the first response is low.

16. A non-transitory, computer-readable medium storing program instructions which when executed by a processor cause the processor to be configured to perform a question answering method comprising:
receiving a question from a questioner terminal via a communication interface;
generating a first response to the question using a first large-scale language model (LLM) executing in a local environment;
generating an accuracy determination for the first response;
providing the question to a second response generation unit when the accuracy determination indicates accuracy of the first response is low; and
sending a second response to the questioner terminal via the communication interface if the second response is received from the second response generation unit after the accuracy determination indicates accuracy of the first response is low.

17. The non-transitory, computer-readable medium according to claim 16, the question answering method further comprising:
sending the first response to the questioner terminal via the communication interface before the accuracy determination is generated.

18. The non-transitory, computer-readable medium according to claim 16, wherein the second response generation unit is a respondent terminal operated by a human.

19. The non-transitory, computer-readable medium according to claim 16, wherein the second response generation unit uses a second LLM that is different from the first LLM.

20. The non-transitory, computer-readable medium according to claim 16, the question answering method further comprising:
updating learning data stored in a storage unit based on the received question and the second response when the second response is received from the second response generation unit after the accuracy determination indicates accuracy of the first response is low.
